(19) United States
(12) Patent Application Publication
(10) Pub. No.: US 2008/0117124 A1
(43) Pub. Date: May 22, 2008

(54) Plasma display panel (PDP)

(76) Inventors: Chong-Gi Hong, Suwon-si (KR); Tae-Kyoung Kang, Suwon-si (KR)

Correspondence Address: Robert E. Bushnell, Suite 300, 1522 K Street, N.W., Washington, DC, 20005, US

(21) Appl. No.: 11/806,657

(22) Filed: Jun. 1, 2007

(30) Foreign Application Priority Data
Nov. 17, 2006 (KR) 10-2006-0114082

(51) Int. Cl. G09G 3/28

(52) U.S. Cl. 345/60

(57) ABSTRACT

A Plasma Display Panel (PDP) includes first and second substrates facing each other; barrier ribs arranged between the first and second substrates to define discharge cells; and a plurality of electrodes extending in a direction between the first and second substrates relative to the discharge cells. The plurality of electrodes include: an oblique terminal line portion converged to a portion in an inactive region where an image is not displayed while obliquely extending from the electrode in an active region where an image is to be displayed; a terminal connection portion extending from the oblique terminal line portion and connected to a driving circuit board; and a dummy terminal portion adjacent to and in parallel with the terminal connection portion to protect a pattern of the terminal connection portion. An adjacent region of the dummy terminal portion with respect to the oblique terminal line portion is cut away to define a predetermined space between the dummy terminal portion, the terminal connection portion, and the oblique terminal line portion.

### CLAIM OF PRIORITY

This application makes reference to, incorporates the same herein, and claims all benefits accruing under 35 U.S.C. § 19 from an application for PLASMA DISPLAY PANEL earlier filed in the Korean Intellectual Property Office on 17 Nov. 2006 and there duly assigned Serial No. 10-2006-0114082.

### BACKGROUND OF THE INVENTION

1. Field of the Invention

The present invention relates to a Plasma Display Panel (PDP), and more particularly, the present invention relates to a PDP that can prevent a short circuit from occurring between a dummy terminal portion and an oblique terminal line portion at an inactive region where electrode terminals are connected to flexible signal lines.

2. Description of the Related Art

Generally, a Plasma Display Panel (PDP) displays an image using a discharge. Since the PDP is excellent in terms of display quality, such as display capacity, luminance, contrast, afterimage, and view angle, and is slimmer compared to a television using a Cathode Ray Tube (CRT), it is spotlighted as a next generation display device.

The PDP includes a front substrate on which sustain and scan electrodes are formed and a rear substrate on which an address electrode is formed. The front and rear substrates are sealed together with barrier ribs interposed therebetween. Discharge cells are defined by the barrier ribs and an inert gas, such as a mixture gas of Ne and Xe, is injected into the discharge cells.

When address and scan voltages are respectively supplied to the address and scan electrodes, a wall charge is generated between the address and scan electrodes and the discharge cells that will be turned on by the address discharge are selected. In addition, when a sustain pulse is supplied to the sustain and scan electrodes, electrons and ions generated by the sustain and scan electrodes travel between the sustain and scan electrodes. A sustain discharge occurs in a selected discharge cell when a sum of the sustain pulse and the wall voltage formed by the wall charge generated from the address discharge exceeds a firing voltage. Vacuum ultraviolet light generated in the discharge cells excite phosphors, and the excited phosphors emit visible light, thereby displaying an image on the PDP.

In the PDP, a dielectric layer covers the sustain and scan electrodes provided on an entire surface of the front substrate to allow for the sustain discharge using a low voltage by generating and accumulating wall charges and to protect the sustain and scan electrodes for the discharge. When the front and rear substrate are sealed together, the barrier ribs provided on the rear substrate closely contact the dielectric layer, thereby defining the discharge cells.

As the PDP becomes more finely pitched, for example, a 42-inch PDP with Full High Definition (FHD) having a resolution of 1920*1080 pixels, an area of each discharge cell is reduced. Therefore, gaps between the address electrodes at the active region where the image is displayed are reduced.

Furthermore, as the PDP becomes more finely pitched, the gaps between the address electrodes become much narrower since a large number of electrode terminals connected to the address electrodes are disposed in a limited space of the active region. Also, as the gaps of electrode terminals become narrower, a gap between an oblique terminal line portion and a dummy terminal portion of the electrode terminals is further reduced.

The electrode terminals are mainly formed of silver (Ag). In the electrode terminals formed of the silver (Ag), a silver migration phenomenon occurs as time goes by.

Therefore, in a conventional PDP, a short circuit may occur between an oblique terminal line portion and a dummy terminal portion of the electrode terminals due to the silver migration. According to experimental product manufacturing data regarding this, it has been noted that 3% of all products have suffered from a short circuit between the oblique terminal line portion and the dummy terminal portion of the electrode terminals.

Therefore, there is a need for a PDP that can fundamentally prevent the short circuit from occurring between the oblique terminal line portion and the dummy terminal portion of the electrode terminals.

### SUMMARY OF THE INVENTION

The present invention provides a Plasma Display Panel (PDP) that can prevent a short circuit from occurring between a dummy terminal portion and an oblique terminal line portion at an inactive region where electrode terminals are connected to the flexible signal lines.

According to an embodiment of the present invention, a PDP includes first and second substrates facing each other, barrier ribs disposed between the first and second substrates to define discharge cells, and a plurality of electrodes extending in a direction between the first and second substrates in accordance with the discharge cells.

The plurality of electrodes includes an oblique terminal line portion converged to a portion in an inactive region where an image is not displayed while obliquely extending from the electrode in an active region where an image is to be displayed, a terminal connection portion extending from the oblique terminal line portion and connected to a driving circuit board, and a dummy terminal portion adjacent to the terminal connection portion in parallel to protect a pattern of the terminal connection portion.

An adjacent region of the dummy terminal portion with respect to the oblique terminal line portion is cut away to provide a predetermined space between the dummy terminal portion, the terminal connection portion, and the oblique terminal line portion.

The dummy terminal portion may have one or more terminals disposed in parallel.

The electrodes in the active region may be address electrodes.

The electrodes may be formed of silver (Ag).

Adjacent portions of all terminals of the dummy terminal portion with respect to the oblique terminal line portion may be cut away to have a length difference from the terminal connection portion.

Length differences between the terminals of the dummy terminal portion and the terminal connection portion are different from each other.

Adjacent portions of some terminals of the dummy terminal portion with respect to the oblique terminal line portion may be cut away to have a length difference from the terminal connection portion.

Adjacent portions of some of terminals of the dummy terminal portion, which are closer to the terminal connection portion, with respect to the oblique terminal line portion are cut away.

Length differences between the cut away terminals and the terminal connection portion may be different from each other.

The distance between the dummy terminal portion and the terminal connection portion may be greater than a distance between terminals of the terminal connection portion.

The distance between the dummy terminal portion and the terminal connection portion may be equal to a width of a terminal of the dummy terminal portion.

### BRIEF DESCRIPTION OF THE DRAWINGS

A more complete appreciation of the present invention and many of the attendant advantages thereof will be readily apparent as the present invention becomes better understood by reference to the following detailed description when considered in conjunction with the accompanying drawings, in which like reference symbols indicate the same or similar components, wherein:

FIG. 1 is a schematic front view of a Plasma Display Panel (PDP) according to an embodiment of the present invention, including a pattern of address electrodes of the PDP;

FIG. 2 is a schematic view of a connection region where address electrodes are connected to flexible signal lines in a PDP according to a first embodiment of the present invention;

FIG. 3 is a schematic view of a connection region where address electrodes are connected to flexible signal lines in a PDP according to a second embodiment of the present invention;

FIG. 4 is a schematic view of a connection region where address electrodes are connected to flexible signal lines in a PDP according to a third embodiment of the present invention; and

FIG. 5 is a schematic view of a connection region where address electrodes are connected to flexible signal lines in a PDP according to a fifth embodiment of the present invention.

### DETAILED DESCRIPTION OF THE EMBODIMENTS

The present invention is described more fully below with reference to the accompanying drawings, in which exemplary embodiments of the present invention are shown. The present invention may, however, be embodied in many different forms and should not be construed as being limited to the embodiments set forth herein. Rather, these embodiments are provided so that this disclosure will be thorough and complete, and will fully convey the concept of the present invention to those skilled in the art.

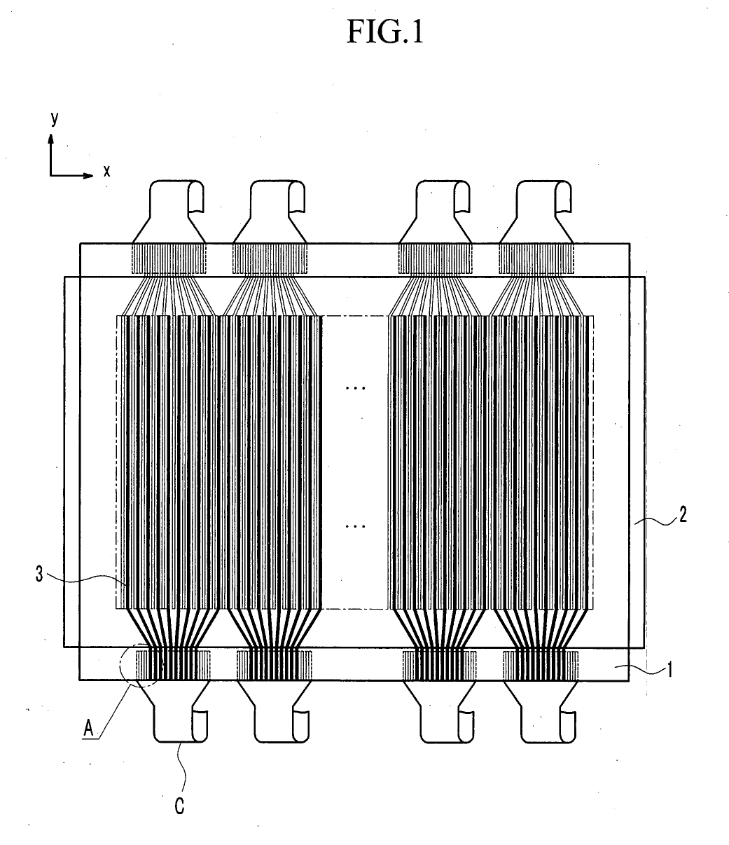

FIG. 1 is a schematic front view of a Plasma Display Panel (PDP) according to an embodiment of the present invention, including a pattern of address electrodes of the PDP.

Referring to FIG. 1, in a Plasma Display Panel (PDP) of this embodiment, an adjacent region of a dummy terminal portion with respect to an oblique terminal line portion at an inactive region where an image is not displayed is cut away, thereby providing a predetermined space between the dummy terminal portion, the oblique terminal line portion, and the terminal connection portion. Therefore, in the PDP of this embodiment, a space between the oblique terminal line portion and the dummy terminal portion is enlarged as compared to a conventional PDP, thereby significantly suppressing silver migration.

Referring to FIG. 1, the PDP includes first and second substrates 1 and 2 (hereinafter “rear and front substrates”) facing each other and spaced apart from each other. The rear and front substrates 1 and 2 are sealed together. Barrier ribs are disposed between the rear and front substrates 1 and 2 to define discharge cells. The discharge cells are filled with an inert gas, such as a mixture gas of Ne and Xe, which generates vacuum ultraviolet light rays during discharge.

Address electrodes 3, sustain electrodes, and scan electrodes are disposed between the rear and front substrates 1 and 2 relative to the discharge cells.

The address electrodes 3 extend in a first direction (the y-axis in the drawing) on the rear substrate 1. The address electrodes 3 are spaced apart from each other by a predetermined gap in a second direction (the x-axis in the drawing) in accordance with the discharge cells.

The sustain and scan electrodes are formed on the front substrate 2 and extend in the second direction (the x-axis in the drawing) crossing the address electrodes 3. The sustain and scan electrodes are spaced apart from each other by a predetermined gap in the first direction (y-axis in the drawing) relative to the discharge cells.

Barrier ribs define the discharge cells formed between the rear and front substrate 1 and 2 in either a stripe pattern or a matrix pattern. A phosphor layer is formed on an inner surface of each of the discharge cells defined by the barrier ribs to emit visible light using the plasma discharge.

In order to realize the plasma discharge, voltages are supplied to the electrodes. The address electrodes 3 are connected to an address driving circuit board by flexible signal lines C.

The address electrodes 3 are spaced apart from each other by a predetermined gap in the second direction (the x-axis in the drawing) in the active region. In addition, in the inactive region where the image is not displayed, the address electrodes 3 are arranged with the following structure in order to be connected with the flexible signal lines C.

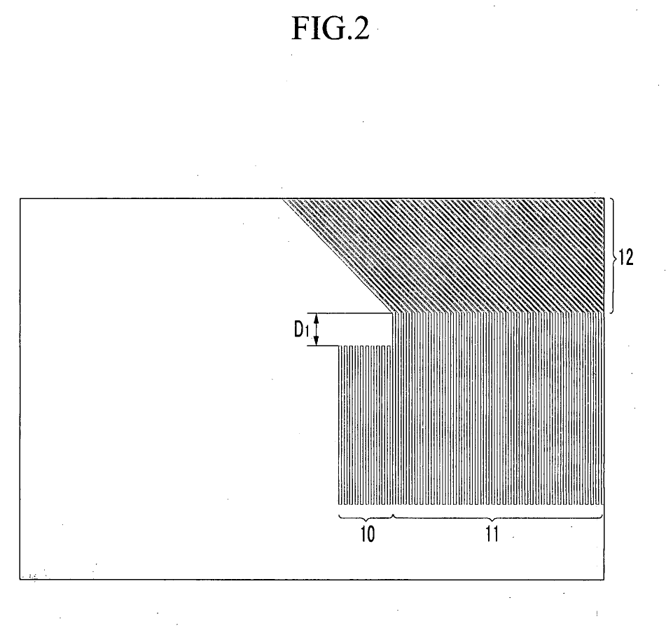

FIG. 2 is a schematic view of a connection region where address electrodes are connected to flexible signal lines in a PDP according to a first embodiment of the present invention.

As shown in FIGS. 1 and 2, a group of the address electrodes 3 includes an oblique terminal line portion 12 converged in the inactive region and obliquely extending from the electrodes disposed in the active region, a terminal connection portion 11 extending from the oblique terminal line portion 12 and connected to an address driving circuit board, and a dummy terminal portion 10 disposed in parallel and adjacent to the terminal connection portion 11 in order to protect a pattern of the terminal connection portion 11.

The dummy terminal portion 10 is formed simultaneously with the forming a pattern of the terminal connection portion 11 in order to protect the terminal connection portion 11 that is an active region during the forming of the electrode pattern. An overall width of the dummy terminal portion 10 may vary according to the design. Generally, one or more dummy terminals are disposed in parallel.

The address electrodes 3 having the dummy terminal portion 10 are usually formed of silver (Ag). Therefore, a silver migration phenomenon may occur between the electrode terminals due to the inherent properties of silver (Ag), as time goes by. Furthermore, as the PDP becomes more highly pitched, for example, a 42-inch PDP with Full High Definition (FHD) has a resolution of 1920*1080 pixels, gaps between the address electrodes 3 are reduced. As a result, the silver migration phenomenon may occur between the dummy terminal portion 10 and the oblique terminal line portion 12. Therefore, in the present embodiment, the dummy terminal portion 10 is formed with the following structure.

That is, an adjacent region of the dummy terminal portion 10 with respect to the oblique terminal line portion 12 is cut away to form a predetermined space between the dummy terminal portion 10, the terminal connection portion 11, and the oblique terminal line portion 12. Describing in more detail, portions of all the terminals of the dummy terminal portions 10, which are close to the oblique terminal line portion 12, are cut away. Therefore, there may be a length difference (D₁) between each terminal of the dummy terminal portion 10 and the terminal connection portion 11. As the length difference D₁ increases, the chance of the occurrence of the silver migration is reduced. However, the length difference D₁ may be kept to a predetermined level so that the dummy terminal portion 10 functions to protect the terminal connection portion 11. The terminals of the dummy terminal portion 10 may be formed to be different in the length difference D₁ with the terminal connection portion 11.

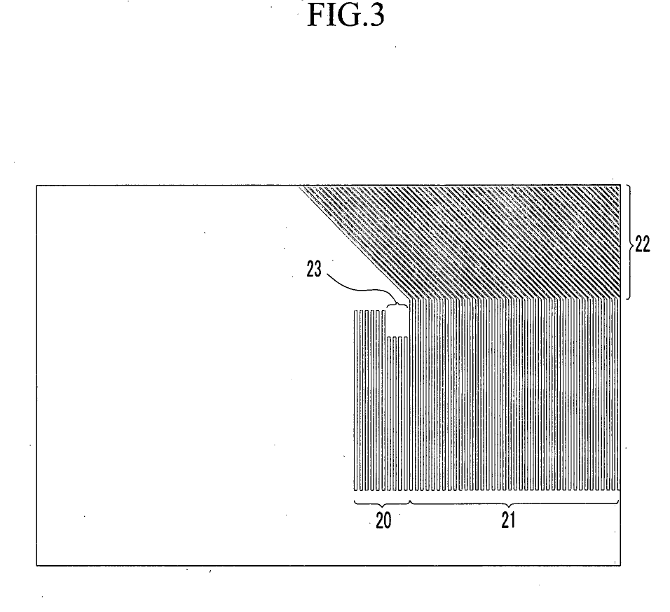

FIG. 3 is a schematic view of a connection region where address electrodes are connected to flexible signal lines in a PDP according to a second embodiment of the present invention.

As shown in FIGS. 1 and 3, adjacent portions of some of terminals of a dummy terminal portion 20, which are closer to the terminal connection portion, with respect to an oblique terminal line portion 22 are cut away. Therefore, a space 23 is provided to a boundary of the dummy terminal portion 20, a terminal connection portion 21, and the oblique terminal line portion 22. As described above, the space 23 is formed at a region where the dummy terminal portion 20 and the oblique terminal line portion 22 are closest to each other, thereby reducing the chance of occurrence of the silver migration phenomenon.

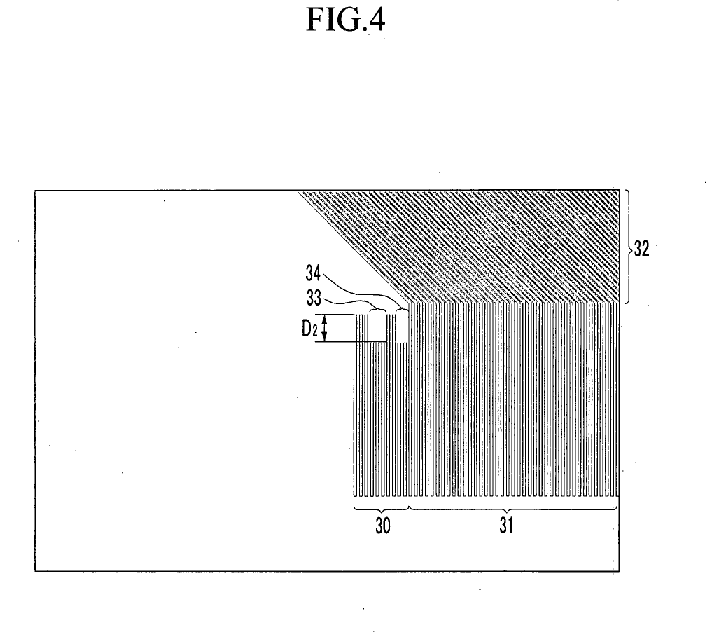

FIG. 4 is a schematic view of a connection region where address electrodes are connected to flexible signal lines in a PDP according to a third embodiment of the present invention.

As shown in FIGS. 1 and 4, adjacent portions of some of terminals of a dummy terminal portion 30 with respect to an oblique terminal line portion 32 are cut away so that there is a length difference D₂ between the terminals of the dummy terminal portion, which are cut, and the terminal connection portion 31 such that two or more spaces 33 and 34 are formed between the terminals of the dummy terminal portion 31. However, one of the spaces 33 and 34 is formed by cutting some of the terminals of the dummy terminal portion 30, which are closer to the oblique terminal line portion 32.

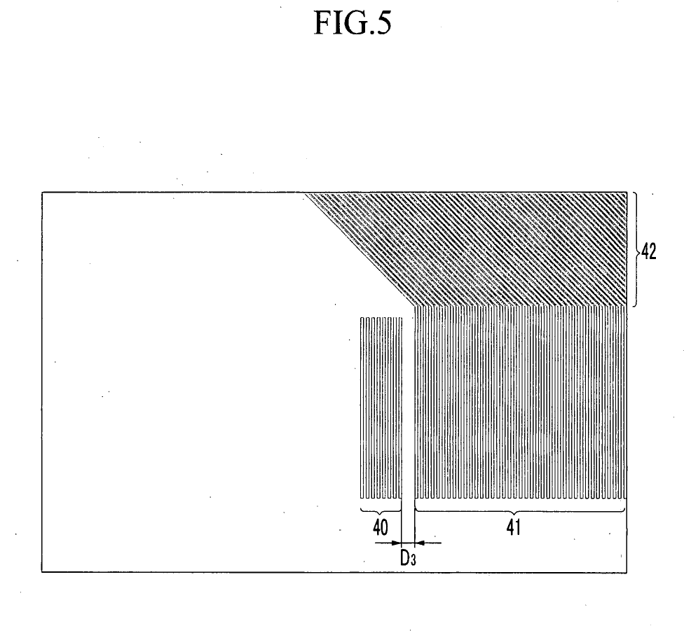

FIG. 5 is a schematic view of a connection region where address electrodes are connected to flexible signal lines in a PDP according to a fourth embodiment of the present invention.

As shown in FIGS. 1 and 5, a distance D₃ between a dummy terminal portion 40 and a terminal connection portion 41 is greater than a distance between terminals of the terminal connection portion 41. That is, one or more terminals of the dummy terminal portion 40, which are closer to the terminal connection portion 41, are removed and thus the distance D₃ between the dummy terminal portion 40 and the terminal connection portion 41 increases. Therefore, the distance D₃ between the dummy terminal portion 40 and the terminal connection portion 41 may be kept as long as an arranged width of one terminal of the dummy terminal portion 40. As a result, a predetermined gap is provided between the dummy terminal portion 40 and the terminal oblique terminal line portion 42, thereby reducing the chance of the occurrence of the silver migration.

Although the above-described embodiments of the present invention are described in connection with the address electrode 3, it is apparent that the same basic concept of the present invention may be applied to the scan or sustain electrodes.

As described above, the dummy terminal portion of the PDP of the present invention is designed to provide a predetermined space between the dummy terminal portion, the terminal connection portion, and the oblique terminal line portion. Therefore, compared to conventional PDPs, the silver migration generated between the oblique terminal line portion and the dummy terminal portion at the inactive region where the electrode terminals are connected to the flexible signal lines is significantly suppressed. Therefore, short circuits between electrodes can be prevented.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. A Plasma Display Panel (PDP) comprising:
first and second substrates facing each other;
barrier ribs arranged between the first and second substrates to define discharge cells; and
a plurality of electrodes extending in a direction between the first and second substrates relative to the discharge cells, the plurality of electrodes including:
an oblique terminal line portion converged to a portion in an inactive region where an image is not displayed while obliquely extending from the electrode in an active region where an image is to be displayed;
a terminal connection portion extending from the oblique terminal line portion and connected to a driving circuit board; and
a dummy terminal portion adjacent to and in parallel with the terminal connection portion to protect a pattern of the terminal connection portion;
wherein an adjacent region of the dummy terminal portion with respect to the oblique terminal line portion is cut away to define a predetermined space between the dummy terminal portion, the terminal connection portion, and the oblique terminal line portion.

2. The PDP of claim 1, wherein the dummy terminal portion has one or more terminals arranged in parallel.

3. The PDP of claim 1, wherein the electrodes in the active region are address electrodes.

4. The PDP of claim 3, wherein the electrodes are of silver (Ag).

5. The PDP of claim 1, wherein adjacent portions of all terminals of the dummy terminal portion with respect to the oblique terminal line portion are cut away to have a length difference from the terminal connection portion.

6. The PDP of claim 5, wherein length differences between the terminals of the dummy terminal portion and the terminal connection portion are different from each other.

7. The PDP of claim 1, wherein adjacent portions of some terminals of the dummy terminal portion with respect to the oblique terminal line portion are cut away to have a length difference from the terminal connection portion.

8. The PDP of claim 7, wherein adjacent portions of some terminals of the dummy terminal portion, which are closer to the terminal connection portion with respect to the oblique terminal line portion are cut away.

9. The PDP of claim 8, wherein length differences between the cut away terminals and the terminal connection portion are different from each other.

10. The PDP of claim 1, wherein a distance between the dummy terminal portion and the terminal connection portion is greater than a distance between terminals of the terminal connection portion.

11. The PDP of claim 10, wherein a distance between the dummy terminal portion and the terminal connection portion is equal to a width of a terminal of the dummy terminal portion.
